(19) United States
(12) Patent Application Publication
(10) Pub. No.: US 2022/0145107 A1
(43) Pub. Date: May 12, 2022

(54) FLAME-RESISTANT PRINT MEDIA COATINGS

(71) Applicant: Hewlett-Packard Development Company, L.P., Spring, TX (US)

(72) Inventors: Zhang-Lin Zhou, San Diego, CA (US); Xiaoqi Zhou, San Diego, CA (US); Xulong Fu, San Diego, CA (US)

(73) Assignee: Hewlett-Packard Development Company, L.P., Spring, TX (US)

(21) Appl. No.: 17/417,547

(22) PCT Filed: Jul. 31, 2019
(86) PCT No.: PCT/US2019/044312

§ 371 Date: Jun. 23, 2021

(51) Int. Cl. C09D 11/30; C09D 11/102; C09D 11/033; C09D 11/54; D06P 5/30; D06P 5/00; D06P 1/52; B41M 5/52

(52) U.S. Cl. CPC C09D 11/30; C09D 11/102; C09D 11/033; B41M 5/5281; D06P 5/30; D06P 5/002; D06P 1/5285; C09D 11/54

(57) ABSTRACT

A flame-resistant print media coating composition includes water and polyurethane particles dispersed in the water. The polyurethane particles include a polyurethane polymer having a polyurethane backbone with urethane linkage groups coupling polymerized diisocyanates and polymerized polymeric diols along the polyurethane backbone. The polyurethane polymer in this example includes aliphatic phosphonium salt capping groups.

### BACKGROUND

Inkjet printing has become a popular way of recording images on various media. Some of the reasons include low printer noise, variable content recording, capability of high-speed recording, and multi-color recording. These advantages can be obtained at a relatively low price to consumers. As the popularity of inkjet printing increases, the types of use also increase providing demand for new print media, for example.

### BRIEF DESCRIPTION OF DRAWINGS

FIG. 1 schematically illustrates an example flame-resistant print media coating composition for coating print media substrates in accordance with the present disclosure;

FIG. 2 schematically illustrates an example coated print media in accordance with the present disclosure;

FIG. 3 provides a flow diagram for an example method of making coated print media in accordance with the present disclosure;

FIGS. 4-6 show example portions of various example polyurethane particles that can be included in flame-resistant print media coating compositions and flame-resistant coated print media in accordance with the present disclosure.

### DETAILED DESCRIPTION

The present technology relates to coating compositions for print media, coated print media, and methods for making print media. These coating compositions and ink-receiving layers applied to print media substrates can include polyurethane particles that provide flame resistance to the coating composition and the coated print media. The presence of aliphatic phosphonium salts as capping groups for the polyurethane backbone can provide this enhanced flame-retardant property. In some examples, to enhance the stability of the polyurethane particles, a polyalkylene oxide can be grafted onto the polyurethane backbone as a sidechain and/or can be incorporated into the polyurethane backbone. The polyalkylene oxide can be added to provide aqueous stability as well as stability in the presence of added salts or other cationic groups, such as the aliphatic phosphonium capping groups. There may also be or alternatively be a polymeric diol present along the polyurethane backbone as well, providing binder properties in some examples. Thus, polyurethane particles can be prepared in some examples, by selecting the correct components for the polymer design, that may be flame-inert and/or flame-retardant, film-forming, stability in water, stability in the presence of a salt or cationic group, and/or provide fixing properties for ink compositions applied thereto during use.

Thus, in one example, a flame-resistant print media coating composition includes water and polyurethane particles dispersed in the water. The polyurethane particles include a polyurethane polymer having a polyurethane backbone with urethane linkage groups coupling polymerized diisocyanates and polymerized polymeric diols along the polyurethane backbone. The polyurethane polymer in this example includes aliphatic phosphonium salt capping groups. In one example, the aliphatic phosphonium salt capping groups can include trialkylphosphonium salts with the three alkyl groups independently including a C1 to C5 straight or branched carbon chain. In another example, the polymerized polymeric diol can be a polymerized polyalkylene oxide diol forming a polyalkylene oxide group positioned along the polyurethane backbone, or the polyurethane polymer includes a polyalkylene oxide sidechain grafted onto the polyurethane backbone, or both can be present. In another example, the polymerized polymeric diol can include a polymerized polyether diol, a polymerized polyester diol, a polymerized polycarbonate diol, or a combination thereof. The polymerized polymeric diol can include multiple types of polymerized polymeric diols, including a first polymerized polymeric diol that forms a polymeric binder portion along the polyurethane backbone, as well as a second polymerized polymeric diol that forms a polyalkylene oxide sidechain attached the polyurethane backbone. The polymerized diisocyanate can include 2,2,4 (or 2,4,4)-trimethylhexane-1,6-diisocyanate, hexamethylene diisocyanate, methylene diphenyl diisocyanate, isophorone diisocyanate, 1-Isocyanato-4-[(4-isocyanatocyclohexyl)methyl]cyclohexane, or combinations thereof. The polyurethane particles can have a D50 particle size from 20 nm to 1,000 nm and a weight average molecular weight from 5,000 Mw to 500,000 Mw, for example.

In another example, a flame-resistant coated print medium incudes a print media substrate and an ink-receiving layer on the print media substrate. The ink-receiving layer includes polyurethane particles of a polyurethane polymer having a polyurethane backbone with urethane linkage groups coupling polymerized diisocyanates and polymerized polymeric diols along the polyurethane backbone. The polyurethane polymer in this example includes aliphatic phosphonium salt capping groups. In one example, the aliphatic phosphonium salt capping groups can include trialkylphosphonium salts with the three alkyl groups independently including a C1 to C5 straight or branched carbon chain. In another example, the polymerized polymeric diol can be a polymerized polyalkylene oxide diol forming a polyalkylene oxide group positioned along the polyurethane backbone, or the polyurethane polymer includes a polyalkylene oxide sidechain grafted onto the polyurethane backbone, or both can be present. The polymerized polymeric diol can include a polymerized polyether diol, a polymerized polyester diol, a polymerized polycarbonate diol, or a combination thereof, and wherein the polymerized diisocyanate includes 2,2,4 (or 2, 4, 4)-trimethylhexane-1,6-diisocyanate, hexamethylene diisocyanate, methylene diphenyl diisocyanate, isophorone diisocyanate, 1-Isocyanato-4-[(4-isocyanatocyclohexyl)methyl]cyclohexane, or combinations thereof. The ink receiving layer can further include a second polymer resin in addition to the polyurethane particles, wherein polyurethane particles and the second polymer resin are present in the ink-receiving layer at a weight ratio from 10:1 to 1:2. In further detail, the print media substrate can be paper, fabric, plastic, metal, or a combination or composite thereof.

In another example, a method of making a flame-resistant coated print medium includes applying a flame-resistant print media coating composition as a layer to a print media substrate and drying the flame-resistant print media coating composition to remove water therefrom on the print media substrate, leaving an ink-receiving layer thereon. The flame-resistant print media coating composition in this example includes polyurethane particles dispersed in the water, the polyurethane particles include a polyurethane polymer having a polyurethane backbone with urethane linkage groups coupling polymerized diisocyanates and polymerized polymeric diols along the polyurethane backbone. The polyurethane polymer in this example includes aliphatic phosphonium salt capping groups. In one example, the polymerized polymeric diol can be a polymerized polyalkylene oxide diol forming a polyalkylene oxide group positioned along the polyurethane backbone, or the polyurethane polymer includes a polyalkylene oxide sidechain grafted onto the polyurethane backbone, or both can be present.

It is noted that when discussing the flame-resistant print media coating compositions (also referred to as “coating compositions”), flame-resistant coated print media (also referred to as “coated print media”), and methods of making the flame-resistant coated print media, these discussions can be considered applicable to one another whether or not they are explicitly discussed in the context of that example. Thus, for example, when discussing polyalkylene oxide moieties related to the coating compositions, such disclosure is also relevant to and directly supported in the context of the coated print media and methods of making coated print media, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

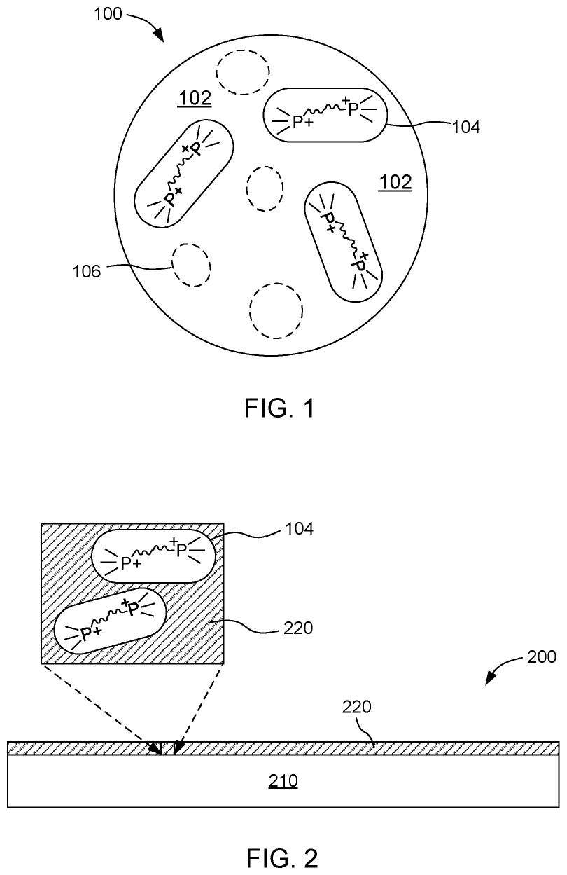

Turning now to more specific detail regarding the flame-resistant print media coating compositions, as shown in FIG. 1, an example coating composition 100 can include liquid vehicle or carrier vehicle 102, which is an aqueous liquid vehicle and thus includes water, and polyurethane particles 104, which are shown schematically in this FIG. and not by way of limitation. The liquid carrier may include surfactant, organic co-solvent, defoamer, or other liquid components helpful for formulating and/or applying to a print media substrate. In some examples, the liquid carrier may be water or predominantly water. The polyurethane particles can have a D50 particle size from 20 nm to 1,000 nm, from 40 nm to 800 nm, from 60 nm to 600 nm, or from 100 nm to 500 nm, for example. The weight average molecular weight of the polyurethane particles can be from 5,000 Mw to 500,000 Mw, from 10,000 Mw to 400,000 Mw, from 20,000 Mw to 250,000 Mw, from 10,000 Mw to 200,000 Mw, or from 50,000 Mw to 500,000 Mw, for example. Also, shown as a dashed circle, there can also be other solids components present, such as a second polymer resin 106, for example. Other secondary solids components that may be present include, for example, cationic fixing agent (e.g., metal inorganic salt, metal organic salt, cationic polymer, etc.), inorganic particulate fillers, optical brightening agents (e.g., 4,4′-diamo-2,2′-stilbenedisulfonic acid, 4,4′-bis(benzoxazoyly-cis-stilbene, 2,5-bis(benzoxazole-2-yl)thiopene, etc.); and/or cross-linking agents.

FIG. 2 provides an example flame-resistant coated print medium 200 with the flame-resistant print media coating composition of FIG. 1 having been applied to a print media substrate 210 and dried, leaving an ink-receiving layer 220 thereon. In one example, as shown in an enlarged view, the ink-receiving layer includes the polyurethane particles 104.

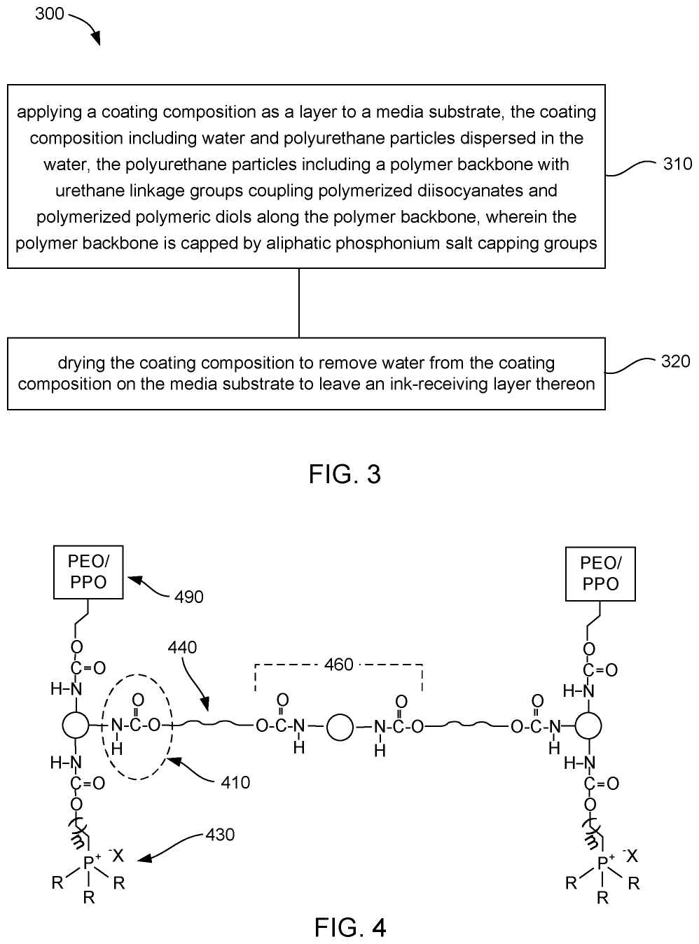

FIG. 3 depicts a method 300 of making a flame-resistant coated print medium that includes applying 310 a flame-resistant print media coating composition as a layer to a print media substrate and drying 320 the coating composition to remove water therefrom on the print media substrate to leave an ink-receiving layer thereon. In this example, the flame-resistant print media coating composition can include water and polyurethane particles dispersed in the water. The polyurethane particles can include a polyurethane backbone with urethane linkage groups coupling polymerized diisocyanates and polymerized polymeric diols along the polyurethane backbone. The polyurethane backbone can be capped by aliphatic phosphonium salt capping groups. In one specific example, the polyurethane particles can further include polyalkylene oxide moieties present as polyalkylene oxide backbone groups, polyalkylene oxide sidechain groups, or both. For clarification, the term “di” is used herein in the context of diisocyanates and diols, but it is understood that when these terms are used broadly to describe classes of materials, rather than to describe a specific compound using appropriate nomenclature, these terms are understood to mean multiple groups. In other words and as an example, if there are three or four hydroxyl groups on a polymer that can be used for forming a polyurethane polymer, then there are also two hydroxyl groups present, e.g., two or more, and thus, these compounds can be considered to be “diols.” That stated, in many examples, diols can be selected for use that have two (and not more) hydroxyl groups present.

FIGS. 4-6 provide example portions of polyurethane particles that can be formed in accordance with the present disclosure. As an initial matter, in FIGS. 4-6, m can be from 1 to 18, from 1 to 14, from 1 to 10, from 2 to 18, from 2 to 10, from 1 to 5, or from 2 to 5, for example. R can independently be straight-chained or branched C1 to C5 or C2 to C5 alkyl, and X can be any counterion suitable for the positively charged phosphorus atom of the phosphonium salt capping group, such as Cl, Br, I, sulfonate, p-toluenesulfonate, trifluoromethanesulfonate, etc.

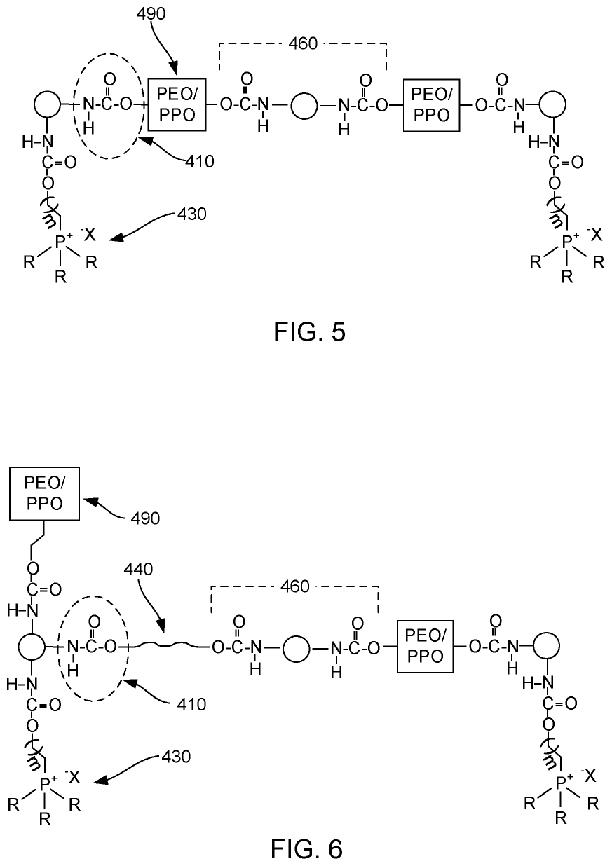

With further reference to FIGS. 4-6, several chemical moieties are schematically shown by way of example, including urethane linkage groups 410, polymerized polymeric diols 440, polymerized isocyanates 460, aliphatic phosphonium salt capping groups 430, and polyalkylene moieties 490. In this specific example, the polyalkylene moieties can be included as a grafted sidechain attached to the polyurethane backbone. The polymerized polymeric diols can likewise form polyalkylene oxides along the backbone to help with water stability or dispersion (along with the PEO/PPO sidechains. Alternatively or additionally, the polymerized polymeric diols can form polymeric binder-type polymeric portions along the backbone to provide binder properties to the polyurethane particles, e.g., polyester diols, polycarbonate diols, etc. Notably, FIG. 4 specifically shows multiple polyalkylene moieties as a pendant sidechain (notated as PEO/PPO). FIG. 5 specifically shows multiple polyalkylene moieties as backbone groups. FIG. 6 specifically shows one polyalkylene moiety as a pendant sidechain and one polyalkylene moiety as a pendant sidechain. “PEO” refers to polyethylene oxide. “PPO” refers to polypropylene oxide, and “PEO/PPO” indicates that the polyalkylene oxide can be polyethylene oxide, polypropylene oxide, or include both types of monomeric units as a hybrid polyalkylene. Further it is noted that these structures are not intended to depict specific polymers, but rather show examples of the types of groups that may be present along the polyurethane chains of the polyurethane particles. For example, there may be additional polymerized polymeric diols, polymerized isocyanates, urethane linkages, polyalkylene oxides, or even other moieties not shown in this example. For example, there may be small molecule diols, organic acid diols, C2-C20 aliphatic diols, functional amine groups derived from isocyanate groups that do not form a urethane linkage, acid groups introduced from sulfonic acid or carboxylic acid diamines, or the like. These and other types of moieties can be included.

In more specific detail regarding the initial reactants that can be used to form the polyurethane particles of the present disclosure, there can be isocyanates that can be reacted with polymeric diols to form urethane linkages. There can also be aliphatic phosphonium salts included as capping groups. Furthermore, in some examples, polyalkylene oxide moieties can be included at various locations. Thus, these four components are described in greater detail hereinafter.

Example diisocyanates that can be used to prepare the pre-polymer (used subsequently to form the polyurethane particles) include 2,2,4 (or 2, 4, 4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexan (H12MDI), etc., or combinations thereof, as shown below. Others can likewise be used alone, or in combination with these diisocyanates, or in combination with other diisocyanates not shown.

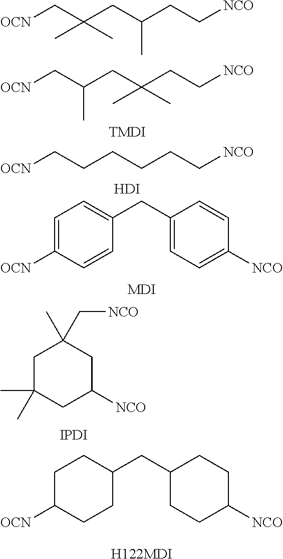

In further detail, to react with the isocyanates to form the urethane linkages and form a pre-polymer (polymer without the aliphatic phosphonium salt capping groups), the reaction can include the use of polymeric diols (and in some instances, other types of diols, e.g., small molecular diols). Example polymeric diols that can be used include polyether diols, such as polyethylene glycol, polypropoylene glycol, or polypolytetrahydrofuran; polyester diols, such as polyadipic ester diol, polyisophalic acid ester diol, polyphthalic acid ester diol; or polycarbonate diols, such as hexanediol based polycarbonate diol, pentanediol based polycarbonate diol, hybrid hexanediol and pentanediol based polycarbonate diol, etc. Combinations of polymeric diols can also be used in polyurethanes such as polycarbonate ester polyether-type polyurethanes, or other hybrid-types of polyurethane particles. In one specific example, however, the polyurethane particles prepared can be polyester polyurethanes. In forming the pre-polymer, the reaction between the polymeric diols and the isocyanates can occur in the presence of a catalyst in acetone under reflux. The resultant pre-polymer may include polymerized polymeric diols and polymerized isocyanates with urethane linkages along the polymer. In some specific examples, other reactants may also be used as mentioned (other types of diols, amines, etc.). Regardless of what type of polyurethane pre-polymer that is formed, the polyurethane particles (without capping groups) can be generated by reacting the pre-polymer with mono-substituted polyethylene oxide (PEO) alcohol and/or polypropylene oxide (PPO) alcohol, or PEO and/or PPO methyl ether, for example, in acetone or other similar solvent to generate a polyurethane polymer with polyalkylene moieties thereon. Notably, to prepare a polyurethane with aliphatic phosphonium salt capping groups without the polyalkylene oxide moieties present, this step can be skipped, for example.

In further detail regarding the polyalkylene oxide moieties that can be included, for example, as a sidechain, the polyalkylene oxide sidechain can be in the form of polyethylene oxide sidechains, polypropylene oxide backbone groups, or a combination thereof. Alternatively, the polyalkylene side chains of any of these types (PEO, PPO, or hybrid) can be copolymerized during formation of the pre-polymer to provide polyalkylene oxide moieties along the backbone. Either way the polyalkylene oxide moieties can have a number average molecular weight from 500 Mn to 15,000 Mn, or from 1,000 Mn to 12,000 Mn, from 2,000 Mn to 10,000 Mn, or from 3,000 Mn to 8,000 Mn.

In preparation for adding the aliphatic phosphonium salt capping groups to the polyurethanes prepared as described above (or otherwise), in examples herein, the aliphatic phosphonium salt can be prepared and then added as a capping group. The following reaction scheme (Equation 1) provides a general method of making, as an example, various aliphatic phosphonium salt-based alcohol that can be added at the polyurethane capping group. More specifically, the following is an example reaction of an alkyl phosphine (I) with a halogenated primary alcohol (II) at a high temperature, e.g., 100° C., to give a trialkylphosphonium salt-based alcohol (III).

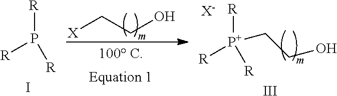

where R can independently be straight-chained or branched C1 to C5 or C2 to C5 alkyl; m can be from 1 to 18, from 1 to 14, from 1 to 10, from 2 to 18, from 2 to 10, from 1 to 5, or from 2 to 5; and X can be any suitable counterion for the positively charged phosphorus atom, such as bromide, chloride, or iodide, sulfonate, p-toluenesulfonate, trifluoromethanesulfonate, for example.

Based on the general reaction scheme shown above as Equation 1, large numbers of example aliphatic phosphonium salt-based alcohols can be synthesized. For example, when R is C1 to C5 alkyl, several example trialkylphosphonium salt-based alcohols can be formed, as shown below:

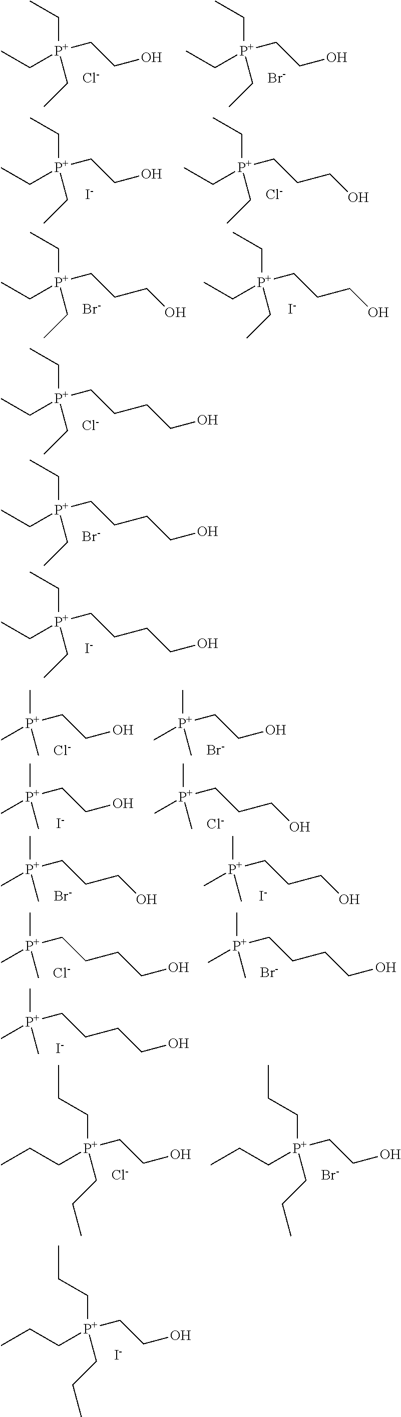

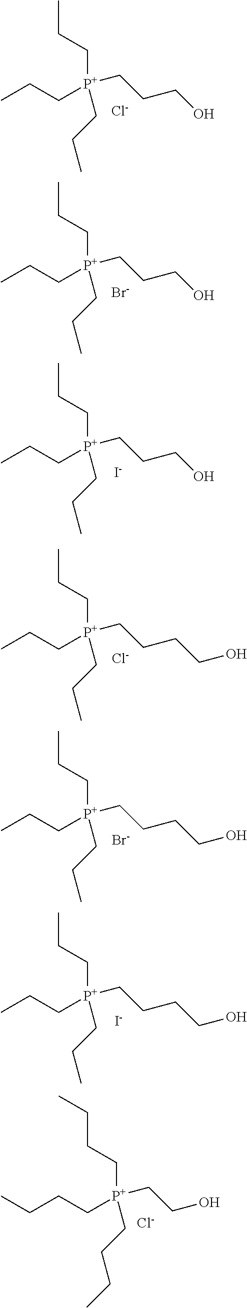

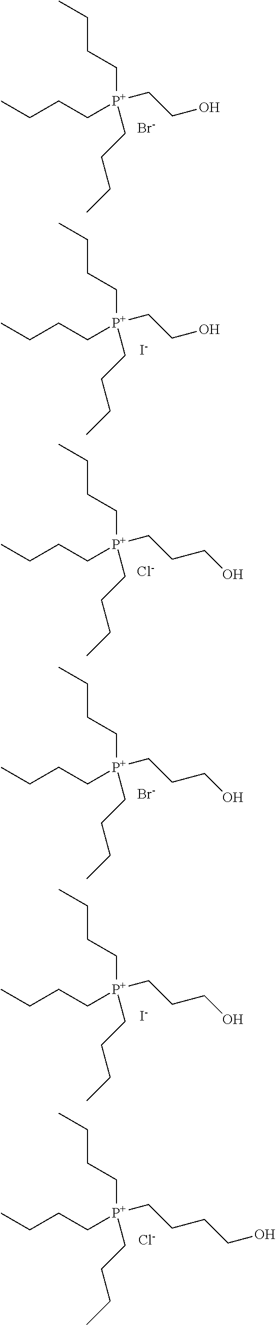

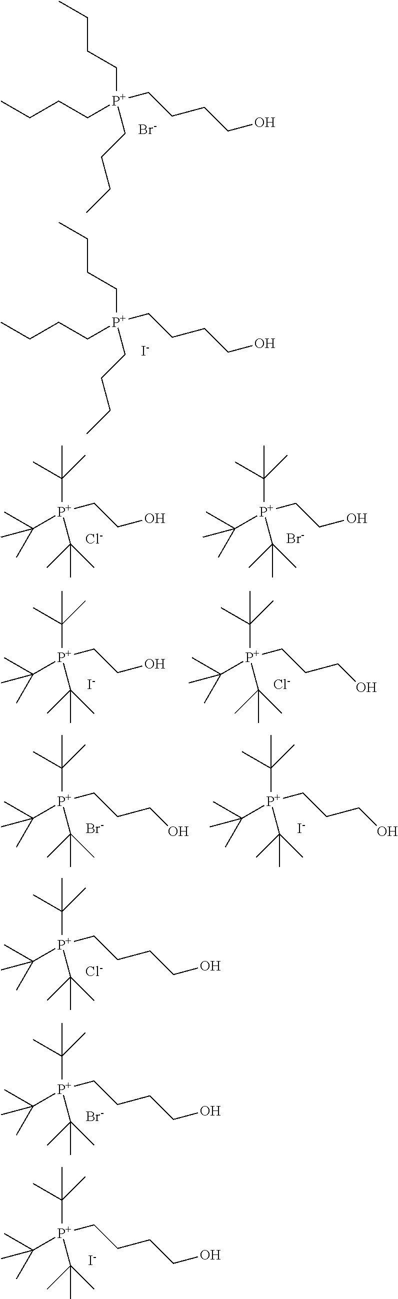

Once the various compounds are prepared and/or otherwise available for polymerization, grafting, or otherwise forming or preparing the polyurethane particles described herein, there are various options that can be implemented in forming the particles. In one example, a polyalkylene oxide can be included in the polyurethane particles. The polyalkylene oxide can be included as a pendant sidechain or along the backbone of the polyurethane, for example.

The following include preparative examples that can be used to form polyurethane particles with polyalkylene oxide sidechains and/or polyalkylene oxide backbone groups, as well as aliphatic phosphonium salt capping groups. In either case, the polyalkylene oxide (as a block polymeric sidechain unit grafted on a backbone or as a backbone moiety) can provide an emulsification functionality for particle stability in water or other aqueous liquid vehicle. Likewise, in cases where there may be a salt present in the flame-resistant print media coating composition or because of the aliphatic phosphonium salt-alcohols added to form the capping groups, the polyalkylene oxides of either or both types can stabilize the polyurethane against prematurely crashing in the coating composition, for example. Furthermore, the aliphatic phosphonium salt, e.g., trialkylphosphonium salt, added as a capping group can enhance flame retardancy of the polyurethane particles, and because it is cationic, can provide a charge center for pigment fixation or crashing (when an ink is printed thereon). These capping groups can be used at concentrations to control molecular weight of the polyurethane particles, with the number of capping units present being used at a ratio relative to the multiple polymer strands to promote an acceptable level of both flame retardancy and pigment binding, for example.

Preparative Reaction Process 1 is provided by way of example below and can be followed to prepare polyurethane particles with the polyalkylene oxide pendant sidechains and aliphatic phosphonium salt capping groups, with an example product shown schematically in FIG. 4.

### Preparative Reaction Process 1

1. Diisocyanate(s)+Polymeric Diol(s) (in the Presence of Catalyst and Acetone or Other Similar Solvent)→Polyurethane Pre-polymer with Polymerized Polymeric Diols and Polymerized Diisocyanates (Copolymerized Together at Urethane Linkage Groups).
2. Polyurethane Pre-polymer+Hydroxylated Polyalkylene Oxide(s)→Polyurethane Pre-polymer with Urethane-grafted Polyalkylene Oxide Sidechains.
3. Polyurethane Pre-Polymer with Urethane-grafted Polyalkylene Oxide Sidechains (having Isocyanate Groups Remaining at Terminal Ends of the Pre-polymer)+Aliphatic Phosphonium Salt-based Alcohol in the Presence of Water (Followed by Removal of Acetone in the Presence of Water)→Polyurethane Particles with Polyalkylene Oxide Sidechains and Aliphatic Phosphonium Salt Capping Groups, similar to that shown in FIG. 4 by Way of Example.

Preparative Reaction Process 2 is provided by way of example below and can be followed to prepare polyurethane particles with the polyalkylene oxide backbone moieties and aliphatic phosphonium salt capping groups, with an example product shown schematically in FIG. 5.

### Preparative Reaction Process 2

1. Diisocyanate(s)+Polyalkylene Oxide Diol Emulsifier (in the Presence of Catalyst and Acetone or Other Similar Solvent)→Polyurethane Pre-polymer with Polymerized Polyalkylene Oxide Diol Emulsifier and Polymerized Diisocyanates (Copolymerized Together at Urethane Linkage Groups).
2. Polyurethane Pre-polymer (having Isocyanate Groups Remaining at Terminal Ends of the Pre-polymer)+Aliphatic Phosphonium Salt-based Alcohol in the Presence of Water (Followed by Removal of Acetone in the Presence of Water)→Polyurethane Particles with Polyalkylene Oxide Moieties along the Backbone and Aliphatic Phosphonium Salt Capping Groups, similar to that shown in FIG. 5 by Way of Example.

In further detail, a structure similar to that shown in FIG. 6 can be prepared by following the methodologies found in both Preparative Reaction Process 1 and Preparative Reaction Process 2, for example.

In addition to the polyurethane particles with aliphatic phosphonium salt capping groups described herein, in some examples, the flame-resistant print media coating compositions can include other components, as mentioned. In one example, the other component can be second polymer resins and/or other small molecular organic compounds, such as crosslinkers. The second polymer resins can be, for example, polyacrylate, polyurethane, vinyl-urethane, acrylic urethane, polyurethane-arcylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, derivative thereof, or combination.

In one example, the second polymer resin can be a polyacrylate. Example polyarcrylate based polymers can include polymers made by hydrophobic addition monomers including, but are not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl arylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmthacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethylhexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), or combinations thereof. Polymers made from the polymerization and/or copolymerization of alkyl acrylate, alkyl methacrylate, vinyl esters, and styrene derivatives may also be useful. In one example, the polyacrylate based polymer can include polymers having a glass transition temperature greater than 20° C. In another example, the polyacrylate based polymer can include polymers having a glass transition temperature of greater than 40° C. In yet another example, the polyacrylate based polymer can include polymers having a glass transition temperature of greater than 50° C.

In one example, the second polymer resin can include a (different) polyurethane polymer. The polyurethane polymer can be hydrophilic. The polyurethane can be formed in one example by reacting an isocyanate with a polyol. Example isocyanates used to form the polyurethane polymer can include toluenediisocyanate, 1,6-hexamethylenediisocyanate, diphenylmethanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, mxylenediisocyanate, tetramethylxylenediisocyanate, 1,5-naphthalenediisocyanate, dimethyltriphenylmethanetetraisocyanate, triphenylmethanetriisocyanate, tris(isocyanatephenyl)thiophosphate, or combinations thereof. Commerically available isocyanates can include Rhodocoat™ WT 2102 (available from Rhodia AG, Germany), Basonat® LR 8878 (available from BASF Corporation, N. America), Desmodur® DA, and Bayhydur® 3100 (Desmodur and Bayhydur available from Bayer AG, Germany). In some examples, the isocyanate can be protected from water. Example polyols can include 1,4-butanediol; 1,3-propanediol; 1,2-ethanediol; 1,2-propanediol; 1,6-hexanediol; 2-methyl-1,3-propanediol; 2,2-dimethyl-1,3-propanediol; neopentyl glycol; cyclohexanedimethanol; 1,2,3-propanetriol; 2-ethyl-2-hydroxymethyl-1,3-propanediol; or combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having at least two isocyanate functionalities and a polyol having at least two hydroxyl or amine groups. Example polyisocyanates can include diisocyanate monomers and oligomers.

In another example, polyurethane pre-polymer can be prepared with an NCO/OH ratio from about 1.2 to about 2.2. In another example, the polyurethane pre-polymer can be prepared with an NCO/OH ratio from about 1.4 to about 2.0. In yet another example, the polyurethane pre-polymer can be prepared using an NCO/OH ratio from about 1.6 to about 1.8. In further detail, the weight average molecular weight of the polyurethane pre-polymer can range from about 20,000 Mw to about 200,000 Mw as measured by gel permeation chromatography. In another example, the weight average molecular weight of the polyurethane pre-polymer can range from about 40,000 Mw to about 180,000 Mw as measured by gel permeation chromatography. In yet another example, the weight average molecular weight of the polyurethane pre-polymer can range from about 60,000 Mw to about 140,000 Mw as measured by gel permeation chromatography.

Example secondary polyurethane polymers can include polyester based polyurethanes, U910, U938 U2101 and U420; polyether-based polyurethane, U205, U410, U500 and U400N; polycarbonate-based polyurethanes, U930, U933, U915 and U911; castor oil-based polyurethane, CUR21, CUR69, CUR99 and CUR991; or combinations thereof. (All of these polyurethanes are available from Alberdingk Boley Inc., North Carolina).

In some examples the polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the polyurethane can include an aromatic polyether polyurethane, an aliphatic polyether polyurethane, an aromatic polyester polyurethane, an aliphatic polyester polyurethane, and a combination thereof. Example commercially-available polyurethanes can include; NeoPac® R-9000, R-9699, and R-9030 (available from Zeneca Resins, Ohio), Printrite™ DP376 and Sancure® AU4010 (available from Lubrizol Advanced Materials, Inc., Ohio), and Hybridur® 570 (available from Air Products and Chemicals Inc., Pennsylvania), Sancure® 2710, Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure® 878, Sancure® 815, Sancure® 1301, Sancure® 2715, Sancure® 2026, Sancure® 1818, Sancure® 853, Sancure® 830, Sancure® 825, Sancure® 776, Sancure® 850, Sancure® 12140, Sancure® 12619, Sancure® 835, Sancure® 843, Sancure® 898, Sancure® 899, Sancure® 1511, Sancure® 1514, Sancure® 1517, Sancure® 1591, Sancure® 2255, Sancure® 2260, Sancure® 2310, Sancure® 2725, Sancure®12471, (all commercially available from available from Lubrizol Advanced Materials, Inc., Ohio), or combinations thereof.

In some examples, the polyurethane can be cross-linked using a cross-linking agent. In one example, the cross-linking agent can be a blocked polyisocyanate. In another example, the blocked polyisocyanate can be blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An example blocked polyisocyanate can include Bayhydur® VP LS 2306 (available from Bayer AG, Germany). In another example, the crosslinking can occur at trimethyloxysilane groups along the polyurethane chain. Hydrolysis can cause the trimethyloxysilane groups to crosslink and form a silesquioxane structure. In another example, the crosslinking can occur at acrylic functional groups along the polyurethane chain. Nucleophilic addition to an acrylate group by an acetoacetoxy functional group can allow for crosslinking on polyurethanes including acrylic functional groups. In other examples the polyurethane polymer can be a self-crosslinked polyurethane. Self-crosslinked polyurethanes can be formed, in one example, by reacting an isocyanate with a polyol.

In another example, the second polymer resin can include an epoxy. The epoxy can be an alkyl epoxy resin, an alkyl aromatic epoxy resin, an aromatic epoxy resin, epoxy novolac resins, epoxy resin derivatives, or combinations thereof. In some examples, the epoxy can include an epoxy functional resin having one, two, three, or more pendant epoxy moieties.

In one example, the epoxy resin can be self-crosslinked. Self-crosslinked epoxy resins can include polyglycidyl resins, polyoxirane resins, or combinations thereof. Polyglycidyl and polyoxirane resins can be self-crosslinked by a catalytic homopolymerization reaction of the oxirane functional group or by reacting with co-reactants such as polyfunctional amines, acids, acid anhydrides, phenols, alcohols, and/or thiols.

In other examples, the epoxy resin can be crosslinked by an epoxy resin hardener. Epoxy resin hardeners can be included in solid form, in a water emulsion, and/or in a solvent emulsion. The epoxy resin hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, ammine adducts with alcohols and emulsifiers, polyamines, polyfunctional polyamines, acids, acid anhydrides, phenols, alcohols, thiols, or combinations thereof.

In addition to the water and the polyurethane particles, and in some instances the second polymer resin and/or crosslinkers, the flame-resistant print media coating composition and ink-receiving layer on the flame-resistant coated print media can include other solids. Examples can include inorganic pigment(s), such as white inorganic pigments if the media is intended to be white, for example. Examples of inorganic pigments that may be used include, but are not limited to, aluminum silicate, kaolin clay, a calcium carbonate, silica, alumina, boehmite, mica and talc, or combinations or mixtures thereof. In some examples, the inorganic pigment includes a clay or a clay mixture. In some examples, the inorganic pigment includes a calcium carbonate or a calcium carbonate mixture. The calcium carbonate may be one or more of ground calcium carbonate (GCC), precipitated calcium carbonate (PCC), modified GCC, and modified PCC, for example. For example, the inorganic pigment may include a mixture of a calcium carbonate and a clay. The particulate fillers can have average particle size ranging from 0.1 μm to 20 μm, with a dry weight ratio of polyurethane particles to particulate filler ranging from 100:1 to 1:20, from 50:1 to 10:1, from 20:1 to 5:1, or from 10:1 to 1:1, for example. A specific example of a particulate filler that can be used is NuCap®, which is available from Kamin, LLC, USA.

In some examples, there are other additives that can be used or included, such as coating composition thickener, such as Tylose® HS-100K, available from SE Tylose GmbH & Co. KG, Germany. Surfactant, such as Pluronic® L61, available from BASF SE, Germany, can also be included. Other commercially-available surfactants that can be used include the TAMOL™ series from Dow Chemical Co., nonyl and octyl phenol ethoxylates from Dow Chemical Co. (e.g., Triton™ X-45, Triton™ X-100, Triton™ X-114, Triton™ X-165, Triton™ X-305 and Triton™ X-405) and other suppliers (e.g., the T-DET™ N series from Harcros Chemicals), alkyl phenol ethoxylate (APE) replacements from Dow Chemical Co., Elementis Specialties, and others, various members of the Surfynol® series from Air Products and Chemicals, (e.g., Surfynol® 104, Surfynol® 104A, Surfynol® 104BC, Surfynol® 104DPM, Surfynol® 104E, Surfynol® 104H, Surfynol® 104PA, Surfynol® 104PG50, Surfynol® 104S, Surfynol® 2502, Surfynol® 420, Surfynol® 440, Surfynol® 465, Surfynol® 485, Surfynol® 485W, Surfynol® 82, Surfynol® CT-211, Surfynol® CT-221, Surfynol® OP-340, Surfynol® PSA204, Surfynol® PSA216, Surfynol® PSA336, Surfynol® SE and Surfynol® SE-F), Capstone® FS-35 from DuPont, various fluorocarbon surfactants from 3M, E.I. DuPont, and other suppliers, and phosphate esters from Ashland, Rhodia and other suppliers. Dynwet® 800, for example, from BYK-chemie, Gmbh (Germany), can also be used.

When applying the flame-resistant print media coating composition to a print media substrate, the coating composition can be applied to any print media substrate type using any method appropriate for the coating application properties, e.g., thickness, viscosity, etc. Non-limiting examples of methods include dipping coating, padding, slot die, blade coating, and Meyer rod coating. When the coating composition is dried by removal of water and/or other volatile solvent content, the coating composition can form an ink-receiving layer. Drying can be carried out by air drying, heated airflow drying, baking, infrared heated drying, etc. Other processing methods and equipment can also be used. For one example, the coated print media substrate can be passed between a pair of rollers, as part of a calendering process, after drying. The calendering device can be any kind of calendaring apparatus, including but not limited to off-line super-calender, on-line calender, soft-nip calender, hard-nip calender, or the like.

In further detail and by way of example, a textile or paper substrate can be modified on single or both sides with the ink-receiving layer. In one example, the ink-receiving layer can be formed on a print media substrate with a dried coating weight from 2 grams/m² (gsm) to 30 gsm, from 3 gsm to 30 gsm, from 3 gsm to 20 gsm, from 4 gsm to 18 gsm, from 5 gsm to 15 gsm, or from 6 gsm to 12 gsm. The coatings of the present disclosure can be applied with varying degrees of smoothness, as well as to provide the ability of the coated media to absorb ink or to evenly distribute ink colorant, e.g., pigment. Furthermore, the flame-resistant coating composition, when applied to a print media substrate, can in many cases act favorably with respect to increased media opacity, brightness, whiteness, glossiness, and/or surface smoothness of image-receiving layer in some examples.

The flame-resistant print media coating compositions, flame-resistant coated print media, and methods of coating print media described herein can be suitable for use with many types of print media, including paper, fabric, plastic, e.g., plastic film, metal, e.g., metallic foil, and other types of printable substrates, including combinations and/or composites thereof. In particular, papers can include chemical pulps and mechanical pulps, e.g., wood containing pulps. Chemical pulp refers to pulp that has been subjected to a chemical process where the heat and chemicals break down the lignin (the substance that binds the cellulose fibers together) without substantially degrading the cellulose fibers. This process removes the lignin from the pulp to thereby yield cellulose fibers having very small amounts of lignin. In mechanical pulp production, the logs of wood are pressed on grinding stones by means of mechanical presses. The wood is split into fibers with the help of water. As a result of which, the wood fibers are released but still contain a large variety of contaminants. The mechanical pulp used in the current disclosure can be further divided into groundwood pulp and the thermo-mechanical pulp (TMP). TMP pulp may be chemically enhanced in some cases, and in such cases, it is referred to as chemo-thermo-mechanical pulp (CTMP). Thus, any kind of cellulose paper stock may be used in the current disclosure, such as paper stock made from wood or non-wood pulps. Non-limitative examples of suitable pulps include chemical pulps, mechanical wood pulp, chemically ground pulp, chemical-mechanical pulp, thermal-mechanical pulp, recycled pulp and/or mixtures.

In another example, textiles or fabrics can be treated with the flame-resistant print media coating compositions of the present disclosure, including cotton fibers, treated and untreated cotton substrates, polyester substrates, nylons, blended substrates thereof, etc. It is notable that the term “fabric substrate” or “fabric media substrate” does not include print media substrate materials such as any paper (even though paper can include multiple types of natural and synthetic fibers or mixtures of both types of fibers). Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

Thus, the fabric substrate can include natural fiber and synthetic fiber, e.g., cotton/polyester blend. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

The basis weight of the print media, such as the paper, fabric, plastic film, foil, etc., can be from 20 gsm to 500 gsm, from 40 gsm to 400 gsm, from 50 gsm to 250 gsm, or from 75 gsm to 150 gsm, for example. Some print media substrates can be toward the thinner end of the spectrum, and other print media substrates may be thicker, and thus, the weight basis ranges given are provided by example, and are not intended to be limiting.

Regardless of the print media substrate used, such substrates can contain or be coated with additives including, but not limited to, colorant (e.g., pigments, dyes, and tints), antistatic agents, brightening agents, nucleating agents, antioxidants, UV stabilizers, and/or fillers and lubricants, for example. Alternatively, the print media substrates may be pre-treated in a solution containing the substances listed above before applying other treatments or coating layers.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

“D50” particle size is defined as the particle size at which about half of the particles are larger than the D50 particle size and about half of the other particles are smaller than the D50 particle size (by weight based on the metal particle content of the particulate build material). As used herein, particle size with respect to the polyurethane particles can be based on volume of the particle size normalized to a spherical shape for diameter measurement, for example. Particle size can be collected using a Malvern Zetasizer, for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM).

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### Examples

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Synthesis of Aliphatic Phosphonium Salt-based Alcohol

2-hydroxylethyltributylphosphonium chloride salt (TBPHECI) was prepared in accordance with Formula 1, and as further described below:

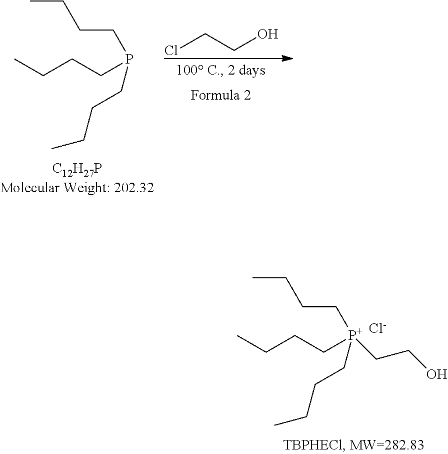

In accordance with Formula 1, a 500 mL four-necked flask equipped with a mechanical stirrer, a thermometer, a dropping funnel, and a condenser was purged with nitrogen and 150 g (0.741 mol) of tri-n-butylphosphine was added. At 80° C., 62.7 g (0.779 mol) of 2-chloroethanol was added dropwise over 30 minutes and the solution turned white and cloudy. The solution was continued to be heated to 100° C. for 2 days under nitrogen and stirring. The reaction solution was very viscous but was colorless and transparent. The presence of unreacted trialklphopshine was tested using carbon disulphide, but trialkylphosphine was not detected. The solution was concentrated using an evaporator and then dried with a vacuum pump to give 206.4 g of a colorless and transparent viscous liquid. The titration purity was 100.0% and the yield was 98.5 wt %.

### Example 2—Preparation of Polyurethane Dispersion 1 (Coating ID D1)

46.386 g of g of polyester diol (Stepanpol PC-1015-55), 14.054 g of isophorone disisocyanate (IPDI), and 64 g of acetone were mixed in a 500 mL of 4-neck round bottom flask. A mechanical stirrer with glass rod and Teflon blade was attached. A condenser was attached. The flask was immersed in a constant temperature bath at 75° C. The system was kept under a drying tube. 3 drops of bismuth caFtalyst (Reaxis C3203) was added to initiate the polymerization. Polymerization was continued for 3 hours at 75° C. 0.5 g samples were withdrawn for % NCO titration to confirm the reaction. 21.401 g of poly(ethylene glycol) methyl ether (Mn=2000) in 10 g of acetone was added to the reactor. The polymerization was continued for 3 hours at 75° C. and 0.5 g of pre-polymer was withdrawn for final % NCO titration. The measured NCO value was 3.55 wt %. The theoretical % NCO should be 3.61 wt %. 18.158 g of the aliphatic phosphonium salt-based alcohol from Example 1 (2-hydroxylethyltributylphosphonium chloride salt) in 20 mL of acetone was added over 10 minutes. After 60 min, the polymerization temperature was reduced to 50° C. and then 227.444 g of DI water was added over 20 minutes. The solution became milky and white in color and the dispersion was continuously stirred overnight at room temperature. The dispersion was filtered through 400 mesh stainless sieve. Acetone was removed with a Rotorvap at 50° C. (add 2 drops—20 mg BYK-011 de-foaming agent). The final dispersion was filtered through fiber glass filter paper. The particle size of the polyurethane particle was measured by Malvern Zetasizer at 169.1 nm. The pH of the dispersion was 6.5. The solids content was 32.25 wt %.

### Example 3—Preparation of Polyurethane Dispersion 2 (Coating ID D2)

25.760 g of g of polyester diol (Stepanpol PC-1015-55), 16.841 g of isophorone disisocyanate (IPDI), and 64 g of acetone were mixed in a 500 mL of 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5 g samples were withdrawn for % NCO titration to confirm the reaction. 25.225 g of poly(ethylene glycol) methyl ether (Mn=2000) in 10 g of acetone was added to the reactor. The polymerization was continued for 3 hours at 75° C. 0.5 g of pre-polymer was withdrawn for final % NCO titration. The measured NCO value was 6.98 wt %. The theoretical % NCO should be 7.03 wt %. 32.143 g of the aliphatic phosphonium salt-based alcohol from Example 1 (2-hydroxylethyltributylphosphonium chloride salt) in 20 mL of acetone was added over 10 minutes. After 60 minutes, the polymerization temperature was reduced to 50° C. and then 241.391 of DI water was added over 20 minutes. The solution became milky and white in color and the milky dispersion was continuously stirred overnight at room temperature. The polyurethane dispersion was filtered through 400 mesh stainless sieve. Acetone was removed with a Rotorvap at 50° C. (add 2 drops—20 mg BYK-011 de-foaming agent). The final polyurethane dispersion was filtered through fiber glass filter paper. The particle size measured by Malvern Zetasizer was 239.3 nm. The dispersion pH was 6.5. The solid content was 33.8 wt %.

### Example 4—Preparation of Polyurethane Dispersion 3 (Coating ID D3)

38.125 g of g of Ymer™ N-120 (PEO-based diol; 1,000 Mw; from Perstorp, Sweden), 23.565 g of isophorone disisocyanate (IPDI), and 64 g of acetone were mixed in a 500 mL of 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5 g of pre-polymer was withdrawn for final % NCO titration. The measured NCO value was 9.20 wt %. The theoretical % NCO should be 9.24 wt %. 38.311 g of the aliphatic phosphonium salt-based alcohol from Example 1 (2-hydroxylethyltributylphosphonium chloride salt) in 20 mL of acetone was added over 10 minutes. After 60 minutes, the polymerization temperature was reduced to 50° C. and then 247.811 of DI water was added over 20 minutes. The solution became milky and white in color and the milky dispersion was continuously stirred overnight at room temperature. The polyurethane dispersion was filtered through 400 mesh stainless sieve. Acetone was removed with a Rotorvap at 50° C. (add 2 drops (20 mg) BYK-011 de-foaming agent). The final polyurethane dispersion was filtered through fiber glass filter paper. The final polyurethane dispersion was filtered through fiber glass filter paper. The particle size measured by Malvern Zetasizer was 13.57 nm. The dispersion pH was 8.0. The solid content was 32.57 wt %.

### Example 5—Preparation of Polyurethane Dispersion 4 (Coating ID D4)

24.926 g of g of Ymer™ N-120 (PEO-based diol; 1,000 Mw; from Perstorp, Sweden), 25.184 g of isophorone disisocyanate (IPDI), and 64 g of acetone were mixed in a 500 mL of 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5 g of pre-polymer was withdrawn for final % NCO titration. The measured NCO value was 14.75 wt %. The theoretical % NCO should be 14.81 wt %. 49.891 g of the aliphatic phosphonium salt-based alcohol from Example 1 (2-hydroxylethyltributylphosphonium chloride salt) in 20 mL of acetone was added over 10 minutes. After 60 minutes, the polymerization temperature was reduced to 50° C. and then 259.391 of DI water was added over 20 minutes. The solution became milky and white in color and the milky dispersion was continuously stirred overnight at room temperature. The polyurethane dispersion was filtered through 400 mesh stainless sieve. Acetone was removed with a Rotorvap at 50° C. (add 2 drops (20 mg) BYK-011 de-foaming agent). The final polyurethane dispersion was filtered through fiber glass filter paper. The particle size measured by Malvern Zetasizer was 307.1 nm. The dispersion pH was 8.0. The solid content was 33.47 wt %.

### Example 6—Preparation of Flame-resistant Coating Compositions (D1-D4) and Comparative Coating Composition (C1)

Five Flame-resistant Coating Compositions were prepared, four coating compositions utilizing the polyurethane dispersions of Examples 2-5 (Coating IDs D1-D4), and one utilizing the comparative polyurethane dispersion (Coating ID C1). The Coating Compositions are provided below in Table 1.

TABLE 1
Coating Compositions

| | D1 | D2 | D3 | D4 | C1 |
|---|---|---|---|---|---|
| | (dry | (dry | (dry | (dry | (dry |
| Component | wt %) | wt %) | wt %) | wt %) | wt %) |
| D1 | 53.8 | — | — | — | — |
| (Phosphonium | | | | | |
| Polyurethane) | | | | | |
| D2 | — | 53.8 | — | — | — |
| (Phosphonium | | | | | |
| Polyurethane) | | | | | |
| D3 | — | — | 53.8 | — | — |
| (Phosphonium | | | | | |
| Polyurethane) | | | | | |
| D4 | — | — | — | 53.8 | — |
| (Phosphonium | | | | | |
| Polyurethane) | | | | | |
| Sancure ™ 2016 | — | — | — | — | 30.3 |
| (Comparative | | | | | |
| Polyurethane) | | | | | |
| Sancure ™ 4010 | — | — | — | ™ — | 23.5 |
| (Comparative | | | | | |
| Polyurethane) | | | | | |
| Araldite ™ PZ 3901 | 22.4 | 22.4 | 22.4 | 22.4 | 22.4 |
| (Second Polymer | | | | | |
| Resin) | | | | | |
| Aradur ® 3985 | 22.4 | 22.5 | 22.4 | 22.5 | 22.4 |
| (Second Polymer | | | | | |
| Resin) | | | | | |
| BYK-Dynwet ® 800 | 0.8 | 0.8 | 0.8 | 0.8 | 0.8 |
| (Surfactant) | | | | | |
| Foamaster ™ | 0.6 | 0.6 | 0.6 | 0.6 | 0.6 |
| (Defoamer) | | | | | |

Sancure ™ polyurethanes are available from Lubrizol Advanced Materials, Inc., USA (unmodified comparative polyurethane).
Araldite ® and Aradur ® polymers are available from Huntsman Advanced Materials (USA).
Dynwet ® surfactant is available from BYK-Chemie (USA).
Foamaster ™ is available from BASF (Germany).

### Example 7—Preparation of Coated Print Media

A polyethylene terephthalate (PET) type polyester fabric with a plain weave having a basis weight of 130 gsm was coated with the coating compositions prepared in accordance with Table 1. The construction details are provided in Table 2 below. The coating composition was applied using a lab Methis padder with the speed of 5 meters per minute, and then the coated fabric was dried using an IR oven at a peak temperature of 120° C. Print Media prepared in accordance with the present disclosure is labeled below as Media 1, Media 2, Media 3, and Media 4 (corresponding with D1-D4 Coating Compositions). Comparative Print Media is labeled below as Comparative Media 1 (coated with different polyurethanes) and Comparative Media 2 (uncoated fabric substrate). All of the coatings were transparent.

TABLE 2
Coated Print Media and Uncoated Print Media

| Media ID | Coating ID | Coat weight |
|---|---|---|
| Media 1 | D1 | 3 gsm |
| Media 2 | D2 | 3 gsm |
| Media 3 | D3 | 3 gsm |
| Media 4 | D4 | 3 gsm |
| Comparative Media 1 | C1 | 3 gsm |
| Comparative Media 2 | None | N/A |

### Example 8—Flame Retardancy

As can be seen by Tables 3, 4 and 5 above, the coated media samples of the present disclosure (Media 1-4) had passing flame resistance, good image quality, and good durability. The print medium coated with a different polyurethane formulation (Comparative Media 1) had good image quality and durability but failed the flame resistance testing protocol. The uncoated print medium was marginal with respect to flame retardancy, but performed poorly with respect to image quality.

Flame-resistance was evaluated using a flame retardancy test (FR) on all of the Coated Print Media from Table 2 (PET fabric with Coatings D1-D4 and C1 as well as an uncoated PET fabric) in accordance with the industrial standard for textiles (NFPA 701). NFPA 701 Pass standard: weight loss less than 40 w % after burning and burning time of residual drops less than 2 seconds. “Residual drops” refer to the melted burning drops from the fabric substrate that occur during the burning test when the samples are handled vertically. The test results are provided in Table 3, as follows:

TABLE 3
Flame Retardancy

| | Weight Loss | Residual Flame | Pass/Fail to NFPA |
|---|---|---|---|
| Media ID | (wt %) | (seconds) | 701 Standard |
| Media 1 | 23.4 | 1.0 | Pass |
| Media 2 | 22.1 | 1.0 | Pass |
| Media 3 | 17.6 | 1.0 | Pass |
| Media 4 | 17.3 | 1.0 | Pass |
| Comparative Media 1 | 20.8 | 12.5 | Fail |
| Comparative Media 2 | 16.4 | 1.9 | Marginal |

As can be seen in Table 3 above, the coated media samples of the present disclosure (Media 1-4) had passing flame resistance. The print medium coated with a different polyurethane formulation (Comparative Media 1) failed the flame retardancy testing protocol. The uncoated print medium was marginal with respect to flame retardancy.

### Example 9—Print Performance (Image Quality and Durability)

Printing image quality and durability tests were carried out by printing a latex- and pigment-containing ink composition using an HP® L360 thermal inkjet printer equipped with an HP® 789 ink cartridge. The printer was set with a heating zone temperature at about 50° C., a cure zone temperature at about 110° C., and an air flow at about 15%. For print image quality, gamut and bleed were evaluated, and the data is provided in Table 4. For print durability, ink transfer, coin scratch, rubbing resistance, wrinkle resistance, and folding resistance were evaluated, and the data is provided in Table 5.

The testing protocols for the data collected above was as follows:
Gamut was measured using a Macbeth TD904 (Macbeth Process Measurement) machine.
Bleed and other image quality issues related to ink migration after printing were evaluated visually on printed samples. Scores ranging from 1 to 5 were used, with 5 indicating the best performance, 1 indicating the worst performance, and a score of 3 is considered passing.
Ink Transfer was tested by using an abrasion scrub tester. For this test, the fabrics were printed with all available colors (cyan, magenta, yellow, black, green, red, and blue). A weight of 250 g was loaded on a test header. The test tip made of acrylic resin with crock cloth was used. The device was set to move the tip at 25 cm/min for a total of 8 inches, cycled 5 times. The test probe was evaluated in dry (dry rub) and wet (wet rub) mode. The ink transferred to the test cloth was evaluated visually. Scores ranging from 1 to 5 were used, with 5 indicating the best performance, 1 indicating the worst performance, and a score of 3 was considered passing.
Coin Scratch was tested on the printed fabrics using all available colors (cyan, magenta, yellow, black, green, red, and blue). The samples were subjected to a scratch testing by a coin-like test header which was 45 degrees facing the surface of the tested samples. Scratching under a normal force of 800 g was used. The test was done in a BYK Abrasion Tester (from BYK-Gardner USA, Columbus, Md.) with a linear, back-and-forth action, attempting to scratch off the image side of the samples (5 cycles). The image durability was evaluated visually. Scores ranging from 1 to 5 were used, with 5 indicating the best performance, 1 indicating the worst performance, and a score of 3 was considered passing.
Rubbing Resistance was tested using all available colors using a dry rub test, where a cloth wrapped on one end of a solid cylinder surface that comes in contact on the ink was rubbed back and forth 5 times with weight ranging from 180 g to 800 g (Taber Industries, 5750 linear abraser). The damage to the printed surface was visually evaluated. Scores ranging from 1 to 5 were used, with 5 indicating the best performance, 1 indicating the worst performance, and a score of 3 was considered passing.
Wrinkle Resistance was evaluated manually by multiple operators (n=5) by crinkling and holding the textile in hands for 1 minute and then placing the fabric samples flatly on a surface and evaluating the degree of wrinkle. Scores ranging from 1 to 5 were used, with 5 indicating the best performance (insignificant wrinkling), 1 indicating the worst performance, and a score of 3 was considered passing.
Folding Resistance was tested by folding printed sheets with four foldings and then placing a weight of 4 pounds on top for 1 hour. The significance of folding lines (or crack degree in the worst cases) was evaluated. Scores ranging from 1 to 5 were used, with 5 indicating the best performance (no significant fold lines), 1 indicating the worst performance (cracking failure), and a score of 3 was considered passing.

TABLE 4
Image Quality

| Media ID | Gamut | Bleed |
|---|---|---|
| Media 1 | 468K | 5 |
| Media 2 | 403K | 5 |
| Media 3 | 450K | 5 |
| Media 4 | 454K | 5 |
| Comparative Media 1 | 455K | 4 |
| Comparative Media 2 | 207K | 3 |

TABLE 5
Durability

| | Ink | Coin | Rubbing | Wrinkle | Folding |
|---|---|---|---|---|---|
| Media ID | Transfer | Scratch | Resistance | Resistance | Resistance |
| Media 1 | 4 | 4 | 5 | 4 | 4 |
| Media 2 | 5 | 5 | 5 | 4 | 4 |
| Media 3 | 4 | 4 | 5 | 4 | 4 |
| Media 4 | 4 | 4 | 4 | 4 | 4 |
| Comparative | 5 | 4 | 5 | 4 | 4 |
| Media 1 | | | | | |
| Comparative | 2 | 4 | 3 | 5 | 5 |
| Media 2 | | | | | |

As can be seen by Tables 4 and 5 above, the coated media samples of the present disclosure (Media 1-4) had good image quality and durability. The print medium coated with a different polyurethane formulation (Comparative Media 1) had good image quality as well, but as mentioned previously, failed with respect to flame retardancy. The uncoated print medium performed poorly with respect to image quality.

What is claimed is:

1. A flame-resistant print media coating composition, comprising:
water; and
polyurethane particles dispersed in the water, the polyurethane particles including a polyurethane polymer having a polyurethane backbone with urethane linkage groups coupling polymerized diisocyanates and polymerized polymeric diols along the polyurethane backbone, wherein the polyurethane polymer includes aliphatic phosphonium salt capping groups.

2. The flame-resistant print media coating composition of claim 1, wherein the aliphatic phosphonium salt capping groups include trialkylphosphonium salts with the three alkyl groups independently including a C1 to C5 straight or branched carbon chain.

3. The flame-resistant print media coating composition of claim 1, wherein the polymerized polymeric diol is a polymerized polyalkylene oxide diol forming a polyalkylene oxide group positioned along the polyurethane backbone, or wherein the polyurethane polymer includes a polyalkylene oxide sidechain grafted onto the polyurethane backbone, or both.

4. The flame-resistant print media coating composition of claim 1, wherein the polymerized polymeric diol includes a polymerized polyether diol, a polymerized polyester diol, a polymerized polycarbonate diol, or a combination thereof.

5. The flame-resistant print media coating composition of claim 1, wherein the polymerized polymeric diol includes multiple types of polymerized polymeric diols, including a first polymerized polymeric diol that forms a polymeric binder portion along the polyurethane backbone and a second polymerized polymeric diol that forms a polyalkylene oxide sidechain attached the polyurethane backbone.

6. The flame-resistant print media coating composition of claim 1, wherein the polymerized diisocyanate includes 2,2,4 (or 2, 4, 4)-trimethylhexane-1,6-diisocyanate, hexamethylene diisocyanate, methylene diphenyl diisocyanate, isophorone diisocyanate, 1-Isocyanato-4-[(4-isocyanatocyclohexyl)methyl]cyclohexane, or combinations thereof.

7. The flame-resistant print media coating composition of claim 1, wherein the polyurethane particles have a D50 particle size from 20 nm to 1,000 nm and a weight average molecular weight from 5,000 Mw to 500,000 Mw.

8. A flame-resistant coated print medium, comprising:
a print media substrate; and
an ink-receiving coating layer on the print media substrate, the ink-receiving layer comprising the polyurethane particles including a polyurethane polymer having a polyurethane backbone with urethane linkage groups coupling polymerized diisocyanates and polymerized polymeric diols along the polyurethane backbone, wherein the polyurethane polymer includes aliphatic phosphonium salt capping groups.

9. The flame-resistant coated print medium of claim 8, wherein the aliphatic phosphonium salt capping groups include trialkylphosphonium salts with the three alkyl groups independently including a C1 to C5 straight or branched carbon chain.

10. The flame-resistant coated print medium of claim 8, wherein the polymerized polymeric diol is a polymerized polyalkylene oxide diol forming a polyalkylene oxide group positioned along the polyurethane backbone, or wherein the polyurethane polymer includes a polyalkylene oxide sidechain grafted onto the polyurethane backbone, or both.

11. The flame-resistant coated print medium of claim 8, wherein the polymerized polymeric diol includes a polymerized polyether diol, a polymerized polyester diol, a polymerized polycarbonate diol, or a combination thereof, and wherein the polymerized diisocyanate includes 2,2,4 (or 2, 4, 4)-trimethylhexane-1,6-diisocyanate, hexamethylene diisocyanate, methylene diphenyl diisocyanate, isophorone diisocyanate, 1-Isocyanato-4-[(4-isocyanatocyclohexyl)methyl]cyclohexane, or combinations thereof.

12. The flame-resistant coated print medium of claim 8, wherein the ink receiving layer further comprises a second polymer resin in addition to the polyurethane particles, wherein polyurethane particles and the second polymer resin are present in the ink-receiving layer at a weight ratio from 10:1 to 1:2.

13. The flame-resistant coated print medium of claim 8, wherein the print media substrate is paper, fabric, plastic, metal, or a combination or composite thereof.

14. A method of making a flame-resistant coated print medium, comprising:
applying a flame-resistant print media coating composition as a layer to a print media substrate, the flame-resistant print media coating composition including:
water, and
polyurethane particles dispersed in the water, the polyurethane particles including a polyurethane polymer having a polyurethane backbone with urethane linkage groups coupling polymerized diisocyanates and polymerized polymeric diols along the polyurethane backbone, wherein the polyurethane polymer includes aliphatic phosphonium salt capping groups; and
drying the flame-resistant print media coating composition to remove water therefrom on the print media substrate to leave an ink-receiving layer thereon.

15. The method of claim 14, wherein the polymerized polymeric diol is a polymerized polyalkylene oxide diol forming a polyalkylene oxide group positioned along the polyurethane backbone, or wherein the polyurethane polymer includes a polyalkylene oxide sidechain grafted onto the polyurethane backbone, or both.
